(19) United States
(12) Patent Application Publication
(10) Pub. No.: US 2014/0375123 A1
(43) Pub. Date: Dec. 25, 2014

(54) CHARGE SYSTEM AND METHOD FOR WIRELESS KEYBOARD

(71) Applicant: HON HAI PRECISION INDUSTRY CO., LTD., New Taipei (TW)

(72) Inventor: CHAN-YU LIN, New Taipei (TW)

(73) Assignee: HON HAI PRECISION INDUSTRY CO., LTD., New Taipei (TW)

(21) Appl. No.: 14/192,866

(22) Filed: Feb. 27, 2014

(30) Foreign Application Priority Data
Jun. 25, 2013 (TW) 102122598

(51) Int. Cl. H02J 9/06; H02J 7/35

(52) U.S. Cl. CPC H02J 9/061; H02J 7/35
USPC 307/23

(57) ABSTRACT

A charge system includes a main body and a wireless keyboard removably mounted on the main body. The wireless keyboard includes a connecting module, a battery charge module, a detecting module and a solar charge module. When the wireless keyboard is mounted on the main body, the main body charges the wireless keyboard, and the battery charge module is charged by the main body. When the wireless keyboard is removed from the main body, the detecting module detects an energy dump of the battery charge module. When the energy dump is not lower than a preset energy, the wireless keyboard is powered by the battery charge module. When the dump energy is lower than the preset energy, the solar charge module powers the wireless keyboard. The patent further discloses a charge method.

### BACKGROUND

1. Field

Embodiments of the present disclosure relate to charging systems and methods, and particularly to a charging system and a method for a wireless keyboard.

2. Background

A wireless keyboard is generally used to connect to an electronic device, such as a tablet computer and a mobile phone, to improve inputting efficiency. The wireless keyboard can be removable from a main body of the electronic device to be connected to another electronic device. However, after the wireless keyboard is removed from the main body, a rechargeable battery powers the wireless keyboard. However, because of the limitation of the capacity of the rechargeable battery the wireless keyboard cannot be used long. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of function modules of a charge system.

FIG. 2 is a block diagram of function modules of a wireless keyboard of the charge system of FIG. 1.

FIG. 3 is a block diagram of function modules of a detecting module of the wireless keyboard of FIG. 2.

FIG. 4 is a block diagram of function modules of a determining module of the wireless keyboard of FIG. 2.

FIG. 5 and FIG. 6 are a flowchart of one embodiment of a charge method using the charge system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

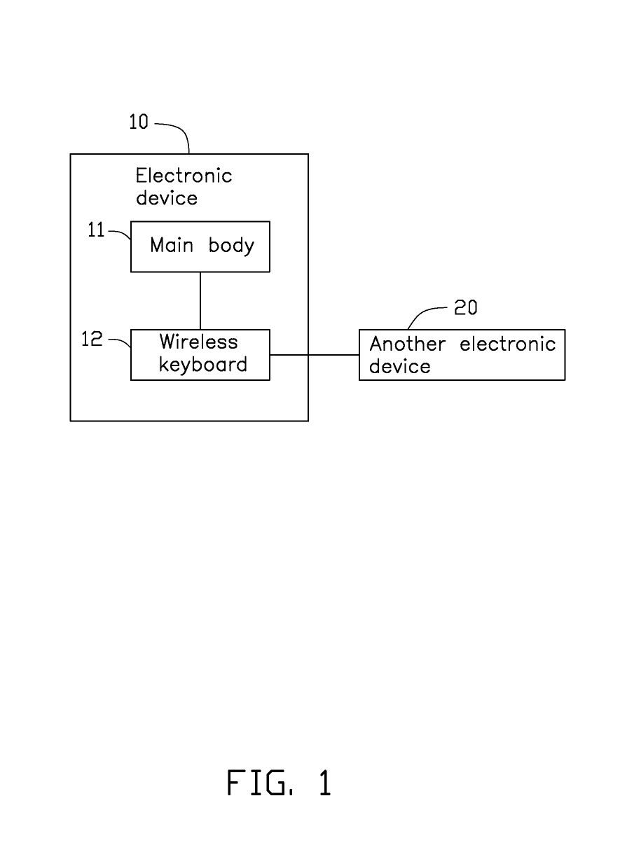

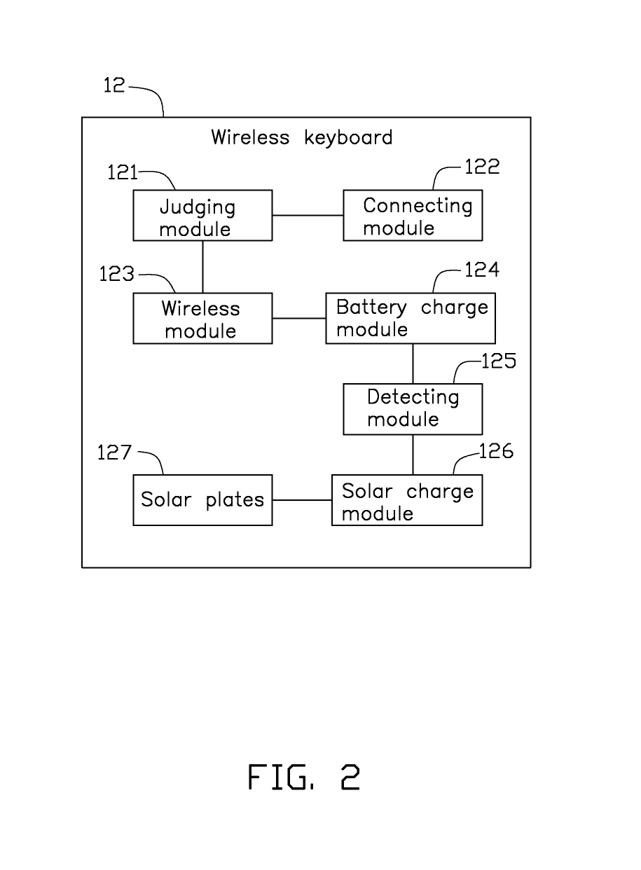

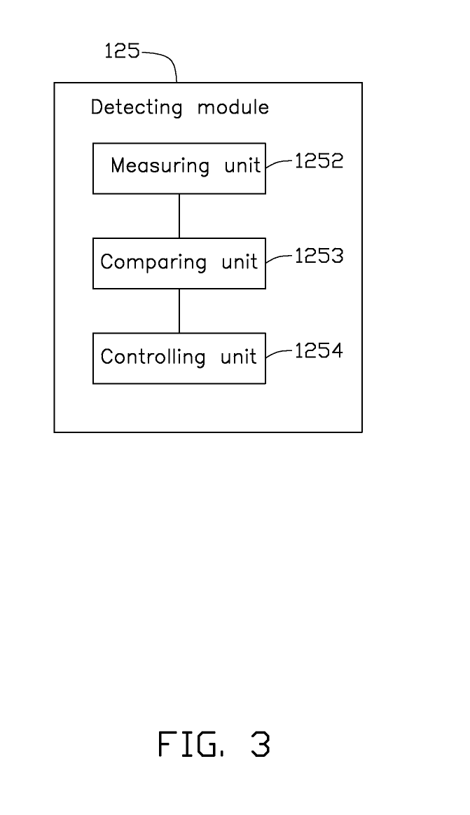

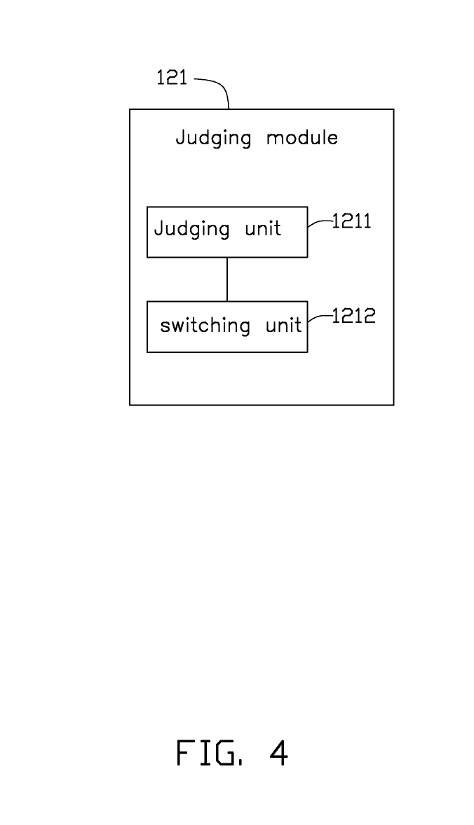

FIGS. 1-4 show one embodiment of an electronic device 10. The electronic device 10 includes a main body 11 and a wireless keyboard 12 removably mounted to the main body 11. The wireless keyboard 12 can be a BLUETOOTH® keyboard connected to the main body 11 or another electronic device via BLUETOOTH®. In one embodiment, the electronic device 10 is a notebook computer, and the another electronic device can be a mobile phone or a tablet computer.

The wireless keyboard 12 includes a determining module 121, a connecting module 122, a wireless module 123, a battery charge module 124, a detecting module 125, and a solar charge module 126. The judging module 121 determines if the wireless keyboard 12 is secured to the main body 11. The connecting module 122 transfers data between the main body 11 and the wireless keyboard 12 when the wireless keyboard 12 is connected to the main body 11. The wireless module 123 can be a BLUETOOTH® module connecting the wireless keyboard 12 to the main body 11 or another electronic device 20 when the wireless keyboard 12 is removed from the main body 11. The battery charge module 124 and the solar charge module 126 power the wireless keyboard 12 when the wireless keyboard 12 is removed from the main body 11. The detecting module 125 detects a power capacity of the battery charge module 124 and then controls the battery charge module 124 or the solar charge module 126 to power the wireless keyboard 12 after being removed from the main body 11. The wireless keyboard 12 further includes a plurality of solar plates 127 for charging the solar charge module 126. The plurality of solar plates 127 are secured to the wireless keyboard 12 and are used for converting the solar energy to electric energy to charge the solar charge module 126.

When the wireless keyboard 12 is secured to the main body 11, the connecting module 122 is connected to the main body 11. When the wireless keyboard 12 is removed from the main body 11, the connecting module 122 is switched off from the main body 11. The judging module 121 judges whether the wireless keyboard 12 is secured to the main body 11 by detecting a connecting state signal from the connecting module 122.

The judging module 121 includes a determining unit 1211 and a switching unit 1212. The judging unit 1211 detects whether the connecting module 122 is connected to the main body 11. The switching unit 1212 switches the wireless module 123 between on or off. When the judging unit 1211 detects the connecting module 122 is connected to the main body 11, the wireless keyboard 12 is secured to the main body 11. In this position, the switching unit 1212 switches off the wireless module 123, and the wireless keyboard 12 is connected to the main body 11 through the connecting module 122. At the same time, the judging module 121 allows the main body 11 to charge the battery charge module 124 using the connecting module, and the detecting unit 1211 switches off the detecting module 125. When the judging unit 1211 detects the connecting module 122 is not connected to the main body 11, the wireless keyboard 12 is removed from the main body 11. In this position, the switching unit 1212 switches on the wireless module 123, and the detecting unit 1211 starts the detecting module 125 to detect an energy dump of the battery charge module 124.

The detecting module 125 includes a measuring unit 1252, a comparing unit 1253, and a controlling unit 1254. The measuring unit 1252 measures the energy dump of the battery charge module 124. The comparing unit 1253 compares the energy dump to a preset energy. The controlling unit 1254 controls the battery charge module 124 or the solar charge module 126 to charge the wireless keyboard 12. The controlling unit 1254 is electronically connected to the battery charger module 124 and the solar charge module 126. When the energy dump is not lower than the preset energy, the comparing unit 1253 sends a first signal to the controlling unit 1254, the controlling unit 1254 switches on the battery charge module 124 and switches off the solar charge module 126, and the battery charge module 124 powers the wireless keyboard 12. When the energy dump is lower than the preset energy, the comparing unit 1253 sends a second signal to the controlling unit 1254, the controlling unit 1254 switches off the battery charge module 124 and switches on the solar charge module 126, and the solar charge module 126 powers the wireless keyboard 12.

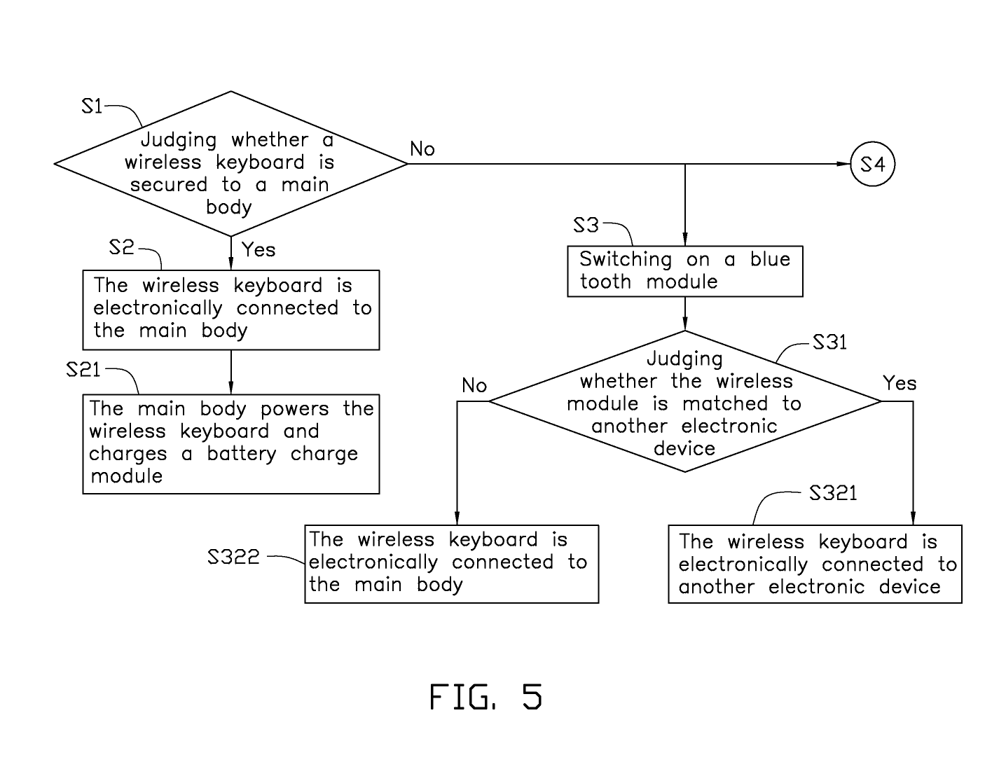

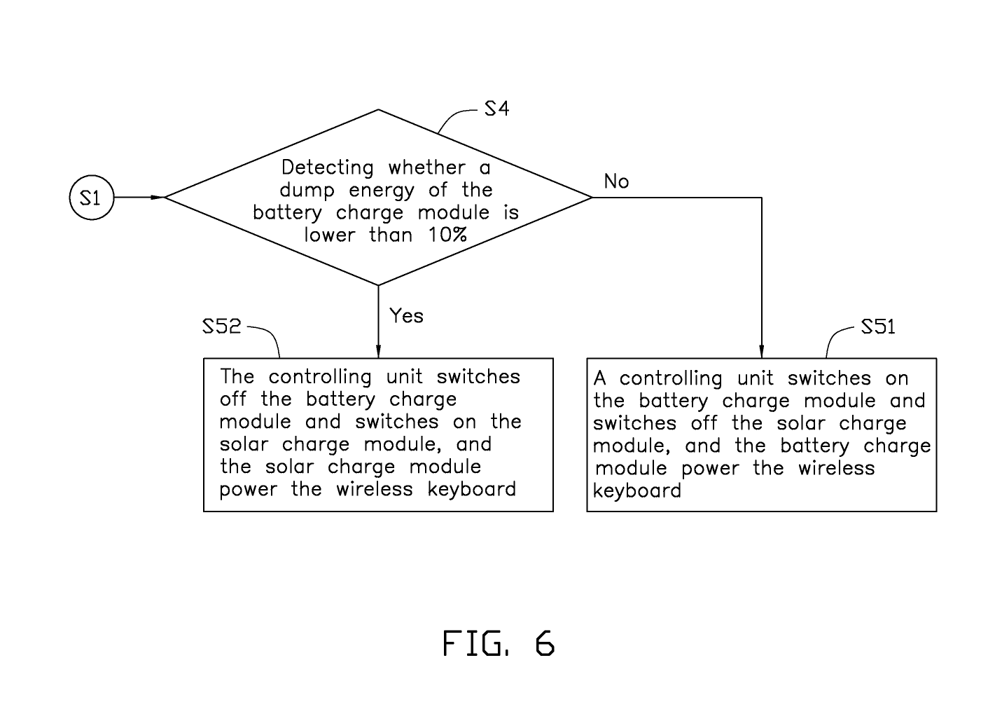

FIG. 5 and FIG. 6 show one embodiment of a charge method.

In step S1: the judging unit 1211 determines whether the wireless keyboard 12 is secured to the main body 11 according to a signal received from the connecting module 122. If the wireless keyboard 12 is secured to the main body 11, the method returns to step S2. If the wireless keyboard 12 is removed from the main body 11, the method goes to step S3.

In step S2: the wireless keyboard 12 is electronically connected to the main body 11 through the connecting module 122.

In step S21: the main body 11 powers the wireless keyboard 12 and charges the battery charger module 124.

In step S3: the switching module 1212 switches on the wireless module 123.

In step S31: the wireless module 123 is determined if matched with another electronic device 20. If the wireless module 123 is matched with another electronic device 20, the method continues to step S321. If the wireless module 123 is not matched with another electronic device 20, the method returns to step S322.

In step S321: the wireless keyboard 12 is electronically connected to another electronic device 20 by wireless means such as BLUETOOTH®.

In step S322: the wireless keyboard 12 is electronically connected to the main body 11 by wireless means such as BLUETOOTH®.

Referring to FIG. 6, in step S4: the detecting module 125 is operated to detect the energy dump of the battery charge module 124 and sends the energy dump to the comparing unit 1253, the comparing unit 1253 compares the energy dump with the preset energy. When the energy dump is equal to or greater than the preset energy, the method turns to step S51. When the dump energy is lower than the preset energy, the method turns to step S52.

In step S51: the controlling unit 1254 switches on the battery charge module 124, switches off the solar charge module 126, and the battery charge module 124 powers the wireless keyboard 12.

In step S52: the controlling unit 1254 switches off the battery charge module 124, switches on the solar charge module 126, and the solar charge module 126 powers the wireless keyboard 12.

The steps S3 and S4 are performed simultaneously.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A charge system, comprising:
a main body; and
a wireless keyboard comprising:
a connecting module electronically connecting the wireless keyboard to the main body when the wireless keyboard is secured to the main body;
a chargeable battery charge module configured to power the wireless keyboard when the wireless keyboard is removed from the main body;
a detecting module configured to detect an energy dump of the battery charge module when the wireless keyboard is removed from the body; and
a solar charge module configured to convert solar energy to electronic energy;
wherein when the wireless keyboard is secured to the main body, the main body powers the wireless keyboard; and when the wireless keyboard is removed from the main body, the detecting module controls the solar charge module to switch on to power the wireless keyboard when the energy dump is lower than a preset energy, and the detecting module controls the battery charge module to switch on to power the wireless keyboard when the energy dump is not lower than the preset energy.

2. The charge system of claim 1, wherein the detecting module comprises a measuring unit, a comparing unit, and a controlling unit; the measuring unit is configured to measure the energy dump of the battery charge module; the comparing unit is configured to compare the energy dump with the preset energy; and the controlling unit is configured to control the battery charge module or the solar charge module to power the wireless keyboard.

3. The charge system of claim 2, wherein the controlling unit is electronically connected to the solar charge module and the battery charge module to switch on/off the solar charge module and the battery charge module.

4. The charge system of claim 1, wherein the wireless keyboard further comprises a solar power plate configured to charge the solar charge module.

5. The charge system of claim 1, wherein the wireless keyboard further comprises a judging module, wherein the judging module comprises a judging unit configured to judge whether the connecting module is connected to the main body; when the wireless keyboard is secured to the main body, the connecting module is electronically connected to the main body, and when the wireless keyboard is removed from the main body, the connecting module is switched off from the main body; and the judging module is configured to judge whether the wireless keyboard is secured to the main body by detecting whether the connecting module is connected to the main body.

6. The charge system of claim 5, wherein the judging module is configured to allow the connecting module to charge the battery charge module when the wireless keyboard is secured to the main board.

7. The charge system of claim 5, wherein the wireless keyboard further comprises a wireless module configured to connect the wireless keyboard to the main body by wireless means; the judging module further comprises a switching unit; when the wireless keyboard is secured to the main body, the switching unit is configured to switch off the wireless module; and when the wireless keyboard is removed from the main body, the switching unit is configured to switch on the wireless module.

8. A charge system, comprising:
a main body; and
a wireless keyboard comprising:
a connecting module electronically connecting the wireless keyboard to the main body when the wireless keyboard is secured to the main body;
a judging module configured to judge whether the connecting module is connected to the main body;
a chargeable battery charge module configured to power the wireless keyboard when the wireless keyboard is removed from the main body;
a detecting module configured to detect dump energy of the battery charge module when the wireless keyboard is removed from the body; and
a solar charge module configured to convert solar energy to electronic energy;
wherein when the wireless keyboard is secured to the main body, the main body powers the wireless keyboard; and when the wireless keyboard is removed from the main body, the detecting module controls the solar charge module to switch to power the wireless keyboard when the dump energy is lower than a preset energy, and the detecting module controls the battery charge module to switch on to power the wireless keyboard when the dump energy is not lower than the preset energy.

9. The charge system of claim 8, wherein the detecting module comprises a measuring unit, a comparing unit, and a controlling unit; the measuring unit is configured to measure the dump energy of the battery charge module; the comparing unit is configured to compare the dump energy with the preset energy; and the controlling unit is configured to control the battery charge module or the solar charge module to power the wireless keyboard.

10. The charge system of claim 9, wherein the controlling unit is electronically connected to the solar charge module and the battery charge module to switch on/off the solar charge module and the battery charge module.

11. The charge system of claim 8, wherein the wireless keyboard further comprises a solar power plate configured to charge the solar charge module.

12. The charge system of claim 8, wherein the judging module comprises a judging unit configured to judge whether the connecting module is connected to the main body; when the wireless keyboard is secured to the main body, the connecting module is electronically connected to the main body, and when the wireless keyboard is removed from the main body, the connecting module is switched off from the main body; and the judging module is configured to judge whether the wireless keyboard is secured to the main body by detecting whether the connecting module is connected to the main body.

13. The charge system of claim 8, wherein the judging module is configured to allows the connecting module to charge the battery charge module when the wireless keyboard is secured to the main board.

14. The charge system of claim 8, wherein the wireless keyboard further comprises a wireless module configured to connect the wireless keyboard to the main body by wireless means; the judging module further comprises a switching unit; when the wireless keyboard is secured to the main body, the switching unit is configured to switch off the wireless module; and when the wireless keyboard is removed from the main body, the switching unit is configured to switch on the wireless module.

15. A charge method for an electronic device comprising a main body and a wireless keyboard, the method comprising:
(a) determining whether the wireless keyboard is secured to the main body;
(b) detecting an energy dump of a battery charging module of the wireless keyboard when the wireless keyboard is removed from the main body;
(c) comparing the energy dump with a preset energy; and
(d) switching on a solar charging module of the wireless keyboard to power the wireless keyboard when the energy dump is lower than the preset energy.

16. The charge method of claim 15, wherein the wireless keyboard is powered by the main body when the wireless keyboard is secured to the main body.

17. The charge method of claim 15, wherein the wireless keyboard is powered by the battery charging module when the energy dump is not lower than the preset energy.

18. The charge method of claim 15, wherein the determining whether the wireless keyboard is secured to the main body by detecting whether a connecting module of the wireless keyboard, which connects the wireless keyboard to the main body, is electronically connected to the main body.

19. The charge method of claim 15, further comprising (e) switching on a wireless module to electronically connect the wireless keyboard to the main body by wireless means after the wireless keyboard is removed from the main body.

20. The charge method of claim 19, wherein the steps (b) and (e) are performed simultaneously.
